(19) United States
(12) Patent Application Publication
(10) Pub. No.: US 2026/0105296 A1
(43) Pub. Date: Apr. 16, 2026

(54) MULTI-MODAL PROMPT GENERATION FOR GENERATIVE ARTIFICIAL INTELLIGENCE

(71) Applicants: AT&T Intellectual Property I, L.P., Atlanta, GA (US); Interwise Ltd., Airport City (IL)

(72) Inventors: Zhengyi Zhou, Chappaqua, NY (US); Eric Zavesky, Austin, TX (US); Venson Shaw, Kirkland, WA (US); Eynat Weinberg Nordman, Ramat Hasharon (IL)

(21) Appl. No.: 18/916,680

(22) Filed: Oct. 15, 2024

(51) Int. Cl. G06N 3/08; G06N 3/0475

(52) U.S. Cl. CPC G06N 3/08; G06N 3/0475

(57) ABSTRACT

Devices, non-transitory computer-readable media, and methods for multi-modal prompt generation for generative artificial intelligence are disclosed. An example method includes identifying a user of a generative artificial intelligence model, detecting an input from the user that triggers a query to the generative artificial intelligence model, wherein the input is received via at least one modality other than a text modality or an image modality, constructing a prompt for the generative artificial intelligence model based on the input, executing the generative artificial intelligence model, using the prompt as an input to the generative artificial intelligence model, to generate an output, and delivering the output to a user endpoint device of the user.

The present disclosure relates generally to machine learning, and relates more particularly to devices, non-transitory computer-readable media, and methods for multi-modal prompt generation for generative artificial intelligence (AI).

### BACKGROUND

Generative artificial intelligence (AI) is artificial intelligence that is capable of generating new text, images, videos, or other data using generative models, usually in response to prompts. Generative AI models learn the patterns and structure of their input training data, and then generate new data that has similar characteristics to the input training data. Thus, generative AI can generate text, images, videos, or other data that did not exist previously, and that meets a set of user-specified criteria (e.g., source code in a specified program that performs a specified function). Generative AI can be either unimodal or multimodal; unimodal systems take only one type of input, whereas multimodal systems can take more than one type of input.

### SUMMARY

Devices, non-transitory computer-readable media, and methods for multi-modal prompt generation for generative artificial intelligence are disclosed. An example method includes identifying a user of a generative artificial intelligence model, detecting an input from the user that triggers a query to the generative artificial intelligence model, wherein the input is received via at least one modality other than a text modality or an image modality, constructing a prompt for the generative artificial intelligence model based on the input, executing the generative artificial intelligence model, using the prompt as an input to the generative artificial intelligence model, to generate an output, and delivering the output to a user endpoint device of the user.

In another example, a non-transitory computer-readable medium stores instructions which, when executed by a processing system including at least one processor, cause the processing system to perform operations. The operations include identifying a user of a generative artificial intelligence model, detecting an input from the user that triggers a query to the generative artificial intelligence model, wherein the input is received via at least one modality other than a text modality or an image modality, constructing a prompt for the generative artificial intelligence model based on the input, executing the generative artificial intelligence model, using the prompt as an input to the generative artificial intelligence model, to generate an output, and delivering the output to a user endpoint device of the user.

In another example, a device includes a processing system including at least one processor and a non-transitory computer-readable medium. The non-transitory computer-readable medium stores instructions which, when executed by the processing system, cause the processing system to perform operations. The operations include identifying a user of a generative artificial intelligence model, detecting an input from the user that triggers a query to the generative artificial intelligence model, wherein the input is received via at least one modality other than a text modality or an image modality, constructing a prompt for the generative artificial intelligence model based on the input, executing the generative artificial intelligence model, using the prompt as an input to the generative artificial intelligence model, to generate an output, and delivering the output to a user endpoint device of the user.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for multi-modal prompt generation for generative artificial intelligence may operate;

FIG. 2 illustrates a flowchart of an example method for multi-modal prompt generation for generative artificial intelligence, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for multi-modal prompt generation for generative AI. As discussed above, generative artificial intelligence (AI) is artificial intelligence that is capable of generating new text, images, videos, or other data using generative models, usually in response to prompts. Generative AI models learn the patterns and structure of their input training data, and then generate new data that has similar characteristics to the input training data. Thus, generative AI can generate text, images, videos, or other data that did not exist previously, and that meets a set of user-specified criteria (e.g., source code in a specified program that performs a specified function). Generative AI can be either unimodal or multimodal; unimodal systems take only one type of input, whereas multimodal systems can take more than one type of input.

Currently, even multimodal generative AI systems are only capable of taking either text or image inputs; modern generative AI systems are not capable of taking inputs in modalities other than a text modality (comprising only text) or an image modality (comprising only image) (such as audio, multimedia, motion, gesture, biometrics, emotion, location, time, extended reality, and/or other modalities). The capabilities of these generative AI systems are therefore limited by their limited input modalities. For instance, a modern generative AI system would not be able to assist in designing and implementing smart home interactions, personal health and/or fitness activities, or other applications that would require inputs from various sensors and/or data types. The limited input modalities also limit personalization of the generated media (e.g., personalization based on user biometrics, location, time context, or the like).

As a separate issue, generative AI models also tend not to be shared efficiently across individual user endpoint devices. This means that a user who uses a generative AI model on multiple user endpoint devices must retrain and contextualize the generative AI model for each operation and user endpoint device. This can lead to inconsistencies in results generated by the generative AI model.

Examples of the present disclosure allow for multimodal generative AI that can accept multimodal inputs beyond text and images, such as video, audio, multimedia, motions, gestures, biometrics, emotions, locations, times, extended reality, and/or other modalities. This enhanced capability may allow a generative AI model to operate as an assistant to enhance user interactions with other individuals, applications, or devices.

Further examples of the present disclosure may leverage Fifth Generation (5G)-generated modalities to provide network-enabled storage of identity, data, and generative AI models in a central network location, authorized aggregation of data and data sources (e.g., sensors) for generative AI model prompt generation, decentralized learning, retrieval, and deployment of generative AI models, effective contextual anomaly detection, and unified privacy and security management.

Further examples of the present disclosure may allow for learning of prompt and context models and embeddings of data that are user-specific and/or task-specific. This, in turn, may allow for more effective management of generative AI models and embeddings through transfer learning and meta learning. This may also allow for secure multi-user determination.

Further examples of the present disclosure may construct and evolve generative AI prompts in an automated manner, with information from a relevant modality. For instance, examples of the present disclosure may automatically add or remove information from modalities as an interaction with the generative AI model progresses.

Further examples of the present disclosure may learn how to select an optimal modality or context for a specified user or task. Learned generative AI models and/or embeddings may be deployed from an open radio access network (O-RAN) on behalf of a user or used to enhance other users' generative AI models.

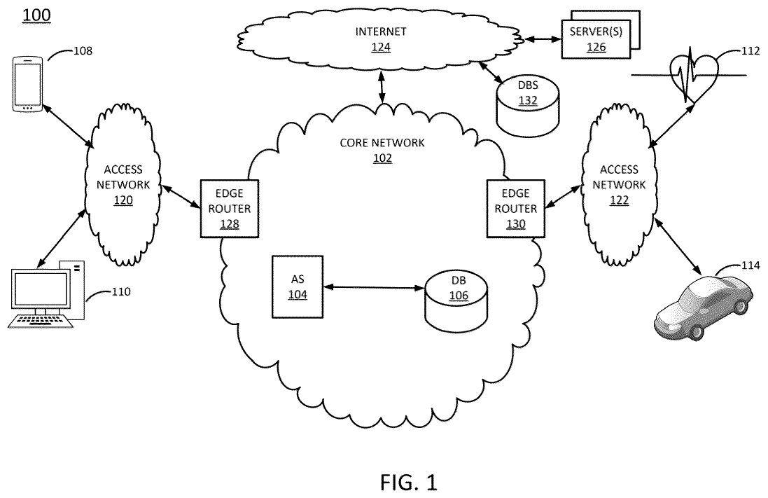

Further examples of the present disclosure may allow for effective detection of anomalies or out-of-distribution (OOD) data based on multi-modal data distribution of an ORAN's history and/or histories of other users. These and other aspects of the present disclosure are discussed in greater detail below in connection with the examples of FIGS. 1-3.

To further aid in understanding the present disclosure, FIG. 1 illustrates an example system 100 in which examples of the present disclosure for multi-modal prompt generation for generative artificial intelligence may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with one or more user endpoint devices 108 and 110. The access network 120 may transmit and receive communications between the user endpoint devices 108 and 110, between the user endpoint devices 108 and 110 and the server(s) 126, the AS 104, other components of the core network 102, devices reachable via the Internet in general, and so forth. Similarly, the access network 122 may be in communication with one or more user endpoint devices 112 and 114. The access network 122 may transmit and receive communications between the user endpoint devices 112 and 114, between the user endpoint devices 112 and 114 and the server(s) 126, the AS 104, other components of the core network 102, devices reachable via the Internet in general, and so forth.

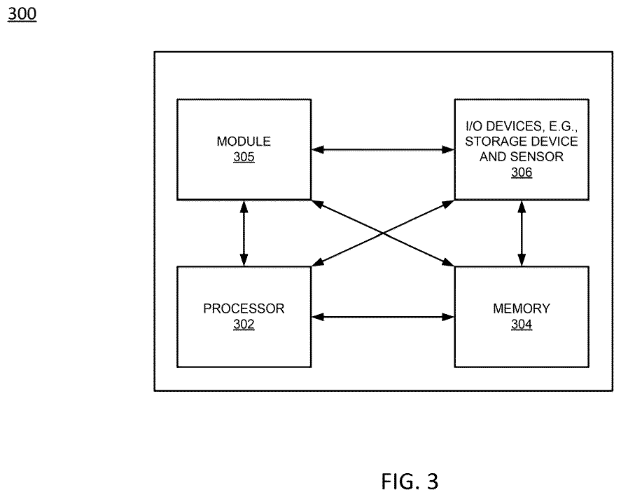

In one example, each of the user endpoint devices 108-114 may comprise any single device or combination of devices that may be used to collect data about a user that can be used in training and/or constructing a prompt for a generative AI model. For example, any of the user endpoint devices 108-114 may comprise a mobile device, a cellular smart phone, a gaming console, an extended reality device, a set top box, a laptop computer, a tablet computer, a desktop computer, an Internet of Things (IoT) device, a wearable smart device (e.g., a smart watch, a fitness tracker, a head mounted display, or Internet-connected glasses), a sensor, and autonomous vehicle (e.g., drone, self-driving automobile, etc.), an application server, a bank or cluster of such devices, and the like. To this end, the user endpoint devices 108-114 may comprise one or more physical devices, e.g., one or more computing systems or servers, such as computing system 300 depicted in FIG. 3, and may be configured as described below.

In one example, one or more servers 126 may be accessible to the user endpoint devices 108-114 via the Internet 124 in general. The server(s) 126 may operate in a manner similar to the AS 104, which is described in further detail below.

In accordance with the present disclosure, the AS 104 and DB 106 may be configured to provide one or more operations or functions in connection with examples of the present disclosure for multi-modal prompt generation for generative AI, as described herein. For instance, the AS 104 may be configured to operate as a hub that collects multimodal data from a plurality of different user endpoint devices 108-114. The multimodal data may comprise data of a plurality of different modalities, including video, audio, multimedia, motions, gestures, biometrics, emotions, locations, times, extended reality, text, images, and/or other modalities. The AS 104 may be further configured to automatically generate a prompt for a generative AI model that causes the generative AI model to generate an output, where the AS 104 uses the multimodal data (including non-text or image data) to construct the prompt.

To this end, the AS 104 may comprise one or more physical devices, e.g., one or more computing systems or servers, such as computing system 300 depicted in FIG. 3, and may be configured as described below. In some examples, the AS 104 may comprise an AI system that may be integrated with other AI systems (potentially located in a workspace of the user endpoint devices 108-114) into a single AI system.

The AS 104 may have access to at least one database (DB) 106, where the DB 106 may store generative AI models and profiles for users of the AS 104. For instance, each user of the AS 104 may be associated with a profile. The profile for a user may identify one or more of the generative AI models that are associated with the user or were created on the user's behalf. The profile may also identify one or more of the user endpoint devices 108-114 associated with the user, where the one or more user endpoint devices may allow the user to provide inputs that can be used in prompts for the generative AI model. In a further example, the profile may identify one or more services to which the user is subscribed, where the services may leverage the generative AI model to provide service to the user. In a further example, the profile may identify one or more preferences of the user (e.g., preferred modalities for providing outputs, preferred languages, and/or other preferences).

The generative AI models stored by the DB 106 may include user-specific generative AI models and/or task-specific generative AI models. Thus, when engaged by a specific user for a specific task, the AS 104 may retrieve an appropriate generative AI model for the user and/or task from the DB 106.

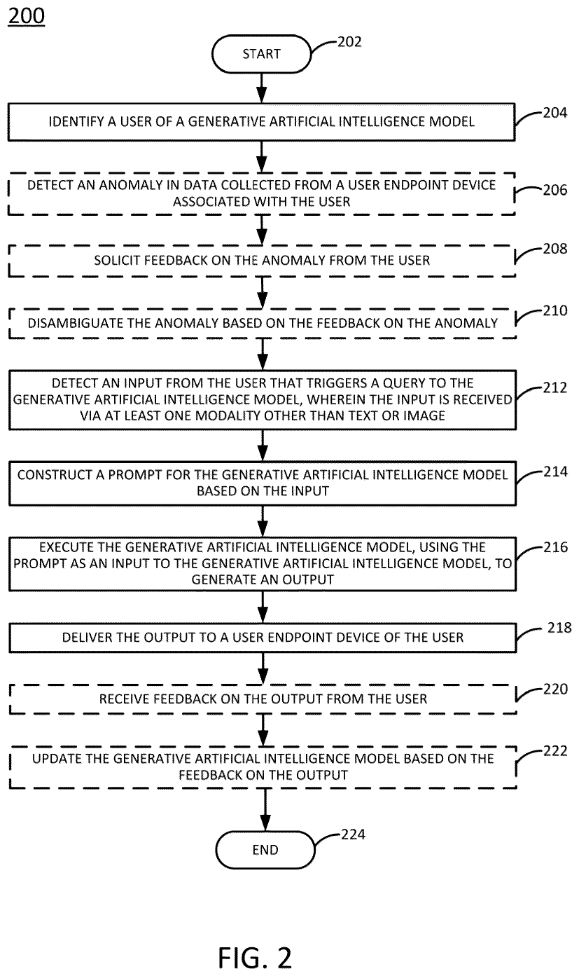

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for multi-modal prompt generation, as described herein. One example method for multi-modal prompt generation for generative artificial intelligence is described in greater detail below in connection with FIG. 2.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, user endpoint devices 108-114 may communicate with the core network 102 via different access networks. Thus, these and other modifications are all contemplated within the scope of the present disclosure.

FIG. 2 illustrates a flowchart of an example method 200 for multi-modal prompt generation for generative artificial intelligence, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may identify a user of a generative artificial intelligence model.

In one example, the user may be an existing user who is identified via a credential checking or authorization process. For instance, the user may log into an application that is hosted by the processing system using a user name and/or password, where the user name may uniquely identify the user. The user name may be associated (e.g., in a database coupled to the processing system) with a profile for the user. The profile for the user may identify one or more generative artificial intelligence models that are associated with the user or were created on the user's behalf. The profile for the user may also identify one or more user endpoint devices associated with the user, where the one or more user endpoint devices may allow the user to provide inputs that can be used in prompts for the generative artificial intelligence model, may allow the generative artificial intelligence model to provide outputs (via the processing system) to the user that are responsive to prompts, and may allow the user to provide feedback to the processing system that is responsive to outputs. In a further example, the profile may identify one or more services to which the user is subscribed, where the services may leverage the generative artificial intelligence model to provide the services to the user. In a further example, the profile may identify one or more preferences of the user (e.g., preferred modalities for providing outputs, preferred languages, and/or other preferences).

In another example, the user may be a new user who is identified via a registration process. As part of the registration process, the processing system may prompt the user to create or provide various information such as a user name and password, identifying information (e.g., name), user endpoint devices associated with the user (which may be used as described above to provide user inputs that can be used in prompts for the generative artificial intelligence model, to provide outputs that are responsive to prompts and that are generated by the generative artificial intelligence model to the user, and to provide user feedback to the processing system that is responsive to outputs). In a further example, the registration process may prompt the user to identify one or more services to which the user wishes to subscribe, where the services may leverage the generative artificial intelligence model to provide the services to the user. In a further example, the registration process may prompt the user to specify one or more preferences of the user (e.g., preferred modalities for providing outputs, preferred languages, and/or other preferences). Any of the information provided by the user during the registration process may be used to create a profile for the user as described above.

It should be noted that the user in this context may be, but does not have to be, a human user. For instance, in some cases, the user could be an automated device, such as an autonomous vehicle, an IoT device, a drone, a virtual decision maker for a smart city, or the like.

In one example, identifying the user may include identifying (e.g., either from an established user profile or through a registration process for a new user) one or more user endpoint devices associated with the user. In one example, the user endpoint devices may include at least one of: a desktop computer, a laptop computer, a tablet computer, a smart phone, a wearable smart device (e.g., a smart watch or fitness tracker), a biometric device (e.g., a blood glucose monitor, a heart monitor, blood oxygenation monitor, or the like), an Internet of Things (IoT) device (e.g., a smart thermostat, a smart home security system, a smart doorbell, a smart lighting system, or the like), a gaming device (e.g., a gaming console), an extended reality device (e.g., a virtual reality/augmented reality headset or pair of glasses), a connected vehicle, or the like. Thus, the one or more user endpoint devices may include local (to the user) devices (e.g., biometric devices) and proximal (to the user) devices (e.g., IoT devices, smart phone, etc.).

In optional step 206 (illustrated in phantom), the processing system may detect an anomaly in the data collected from a user endpoint device associated with the user. In one example, once the identity of the user and one or more user endpoint devices associated with the user have been identified, the processing system may begin collecting data from the one or more user endpoint devices. In a further example, the processing system may additionally collect data from one or more user endpoint devices or data sources not explicitly associated with the user, such as sensors located in proximity to the user's current location, news sources, metadata and/or user reviews associated with the user's current location (e.g., a restaurant, a store, or the like), or other data sources.

The data may be collected in a variety of modalities. For instance, a biometric device may provide one or more biometric readings associated with the user (e.g., heart rate, blood oxygenation, blood glucose level, etc.); a mobile phone may provide text provided by the user or audio samples of the user speaking or making other utterances or may provide a current location (e.g., global positioning system coordinates, an identifier of a last RAN base station or cell to which a user endpoint device of the user attached, etc.) of the user; a smart home security system may provide still images or video of the user; an extended reality device may provide audio and/or images of an augmented reality or virtual reality environment the user is currently experiencing or gestures the user is making; and so on.

Where the user is an existing user whose profile has already been established, the processing system may compare collected data to historical data for the user, where the historical data may have been processed to create a baseline or a distribution of user behavior. Where the user is a newly registered user whose profile has not been fully established, the processing system may compare collected data to historical data for a similar or representative/composite user. By comparing the collected data to the historical data, the processing system may be able to detect when the user's current behavior (as reflected in the collected data) is anomalous or out of distribution. For instance, the processing system may detect that the current value of a particular biometric reading is outside of a distribution of “normal” values for the user.

In optional step 208 (illustrated in phantom), the processing system may solicit feedback on the anomaly from the user. In one example, the processing system may send information about the anomaly to the user (e.g., to a user endpoint device associated with the user) and may request that the user verify the authenticity or accuracy of the data that represents the anomaly. For instance, where the anomaly comprises a current value of a particular biometric reading that is outside of a distribution of “normal” values for the user, the processing system may request that the user provide explicit confirmation that the current value is accurate or may request that the device that measured the biometric reading repeat the measurement.

In another example, rather than seeking feedback directly from the user in step 208, the processing system may apply a default rule, category, or model of an anomaly scenario that the user or system has pre-defined. In this case, soliciting the feedback may comprise comparing the anomaly against the default rule, category, or model in order to make a determination as to how to treat the anomaly.

In optional step 210 (illustrated in phantom), the processing system may disambiguate the anomaly based on the feedback on the anomaly. In one example, the processing system may determine whether the anomaly represents a legitimate data point or is an error, based on the feedback solicited in step 208. For instance, where the anomaly comprises a current value of a particular biometric reading that is outside of a distribution of “normal” values for the user, the feedback on the anomaly may comprise confirmation that the current value is accurate, may comprise a new value that either matches (within some tolerance) or refutes the current value, or may comprise an explanation from the user as to why the current value is anomalous (e.g., the device battery is low, a RAN signal in the user's current location is weak, the user is experiencing a medical event, or the like). If the anomaly is determined to be an error, then the processing system may discard the anomaly. If, however, the anomaly is determined to be a legitimate data point (not an error), then the processing system may process the anomaly as any other legitimate data would be processed (e.g., as described in further detail with respect to steps 212-222).

In step 212, the processing system may detect an input from the user that triggers a query to the generative artificial intelligence model, wherein the input is received via at least one modality other than text or image. For example, the input may be in the form of any one or more of a plurality of modalities, such as a video modality, an audio modality, a multimedia modality, a motion modality, a gesture modality, a biometrics modality, an emotion modality, a location modality, a time modality, a speech characteristic modality, an extended reality modality, and/or other modalities. The input may also be in the form of a speech characteristic that is derived from an audio clip of user speech (where the speech characteristic may be an audible attribute of the speech as opposed to the actual words spoken, such as an emotional intent of the speech, a stress in the speech, a cadence of the speech, a presence of slurring in the speech, a presence of an accent in the speech, a presence of an articulation error in the speech, or the like). In the case of extended reality, the input may comprise a virtual input created by the user in an augmented or virtual reality environment (e.g., a drawing, craft, or other simulated input). In one example, one or more components of the input may additionally be in the form of text or image, but at least one component of the input is in a modality that is not text or image. For instance, the input might comprise one component that is an audio clip of an utterance and also another component that is an image of the person who spoke the utterance.

In one example, the processing system may utilize a set of predefined rules to determine when an input from the user triggers a query. For instance, a rule may define a specific event, utterance, sensor reading, or the like that should cause a query to be submitted to the generative artificial intelligence model.

In one example, the input may correspond to an active trigger or a passive trigger. An active trigger may comprise, for instance, an explicit question (collected in the form of an utterance, a text message, an image, or the like). A passive trigger may comprise, for instance, a detected change in a sensor reading.

In one example, the processing system may derive a context for the query from the input (e.g., from at least one component of the input). For instance, the input may comprise an audio clip of a user utterance that asks, “Where is the nearest gas station?” as well as global positioning system coordinates for a current location of the user. The current location of the user may provide context for the query. For instance, the nearest gas station cannot be determined unless the user's current location is known. Knowing the user's current location will allow a determination as to which gas station of a plurality of possible gas stations is nearest to the user at the time of the query.

In another example, where an anomaly detected in step 206 is determined to be accurate or authentic (e.g., not simply an error), the anomaly may serve as a trigger that explicitly prompts the generation of a query to the generative artificial intelligence model. For instance, if the anomaly corresponds to unusual or unexpected visual data (e.g., an unexpected hand gesture or facial expression), this unusual or unexpected visual data may be utilized as an input to trigger continued processing (instead of repeating the feedback solicitation of step 208). In another example, an anomaly may be simultaneously detected (e.g., per step 206), annotated with feedback (e.g., per step 208), and disambiguated (e.g., per step 210), but additionally included as a general trigger for a query. In this case, an unusual or unexpected hand gesture or facial expression may be disregarded, but the processing system may incorporate the unusual or unexpected hand gesture or facial expression as an input to trigger a generated compensation measure that is used in subsequent anomaly detection (e.g., subsequent iterations of step 206).

In step 214, the processing system may construct a prompt for the generative artificial intelligence model based on the input. In one example, constructing the prompt may involve encoding the query into the prompt, e.g., in a format that can be input to the generative artificial intelligence model. As discussed above, the processing system may select and create contexts for the query using components of the input from one or more modalities.

In one example, an existing generative artificial intelligence model and/or embedding for the user and/or a task associated with the query may be available. For instance, a profile for the user may specify a user-specific generative artificial intelligence model or embedding that was previously created for the user and that may be used to generate prompts or contexts for prompts. The user-specific generative artificial intelligence model or embedding may also be task-specific. For instance, the user profile may specify multiple different generative artificial intelligence models or embeddings for the user, where each different generative artificial intelligence model or embedding is trained to perform a different task on behalf of the user (and according to preferences or requirements of the user). As an example, a first generative artificial intelligence model may have been generated to provide navigation assistance for the user, while a second generative artificial intelligence model may have been created to assist the user in composing emails. In another example, task-specific generative artificial intelligence models or embeddings that are user-agnostic may also be accessible to the processing system. Thus, where available, the processing system may utilize a user-specific and/or task-specific generative artificial intelligence model or embedding to assist in the construction of the prompt.

In one example, the processing system may submit an intermediate solution or exemplar to the user for approval or for further information prior to constructing the final prompt. For instance, in the above example where the input comprises an audio clip of a user utterance that asks, “Where is the nearest gas station?” as well as global positioning system coordinates associated with Globe Life Field in Arlington, Texas, the processing system may send a proposed query to the user that searches for gas stations near Globe Life Field and ask the user to verify (or correct) the physical search area before submitting the prompt to the generative artificial intelligence model.

In a further example, the processing system may use a history associated with the user to construct the prompt. For instance, the processing system may examine the history to look for context, to disambiguate between multiple possibilities, or to facilitate prompt construction in some other way. As an example, the processing system may determine, based on the user history that the user prefers to receive navigation directions in audio form when the user is driving.

In one example, the processing system may include intelligence for determining which component of multiple possible components of the input (which may be in multiple modalities) are most salient for use in constructing a prompt. For instance, if the input comprises a scene of a video game, the processing system may differentiate between foreground and background characters in the game's video and audio, so that video and audio of the different characters can be used in different ways in prompt construction. In some examples, the user may explicitly indicate which components are most salient; however, in other examples, the processing system may learn to differentiate components that are most salient over time.

In one example, the processing system may include intelligence for determining how to construct a prompt from various modalities (e.g., the appropriate data granularity, sessionization, preparation, aggregation, order, pretext, and/or augmentation for each modality). How to construct the prompt may be determined by rules and preferences or learned as models or embeddings. The construction rules or models may also vary by task, time, location, and/or context for each modality. For instance, biometrics information may be included as a daily summary for one query, but as a detailed second-by-second time series for another query; audio data may be processed and augmented with different lengths of prior history as location and/or time vary to differentiate work/home context.

In a further example, the generative artificial intelligence model may be used to create additional constructions or steps that will be internally executed in subsequent steps. Specifically, the generative artificial intelligence model may use methods for generating source code dynamically (e.g., for databases and structured query language execution, application programming interface functional calls, or other low-level computer code executions) to populate a prompt template or generate the content for the prompt directly. In this context, the autonomous generation and execution of an internal prompt may be recognized as an agent execution. The input to the agent may be one or more of the inputs from various modalities captured in step 212. Thus, in a related example, one or more generative sub-executions (e.g., executions of multiple agents) may be utilized such that a prompt is wholly generated within step 214. In an additional example, multiple sub-executions may occur such that the prompt is not only generated but also verified autonomously. Specifically, the processing system may determine that the different modalities (e.g., visual input of a hand moving versus an audio input of the sound of a clap or snap) are not aligned compared to historical, non-anomalous sensor data (e.g., as determined according to steps 206-210) and may create additional agent steps to refine the input data (e.g., sharpen the visual input) or trigger the construction of a different, dynamically selected prompt (e.g., generate a solicitation message for medical attention).

In step 216, the processing system may execute the generative artificial intelligence model, using the prompt as an input to the generative artificial intelligence model, to generate an output. In one example, the generative artificial intelligence model may be a language model, such as a large language model (LLM) or a small language model (SLM).

In one example, the output may be generated in any one or more of the modalities that the generative artificial intelligence model is capable of taking as an input. For instance, one or more components of the output may comprise audio, multimedia, motion, gesture, biometrics, emotion, location, time, extended reality, text, images, and/or other modalities. In one example, the prompt may be constructed (e.g., based on user history, user input, or other data) to request that the generative artificial intelligence model generate the output in one or more specific modalities. For instance, if contextual information (e.g., images of the user behind a steering wheel, rapid change of user location, or other information) indicates that the user is most likely driving, and the prompt requests that the output be generated in audio form, then the generative artificial intelligence model may generate the output in audio form if possible.

In some examples, the output may comprise computer readable instructions. For instance, if the prompt requests navigation assistance, and the user is determined to be sitting in an autonomous or connected vehicle, then the output may comprise computer readable instructions that can be delivered directly to the vehicle to control operation of the vehicle. IoT devices and other devices may be controlled in a similar manner.

In step 218, the processing system may deliver the output to a user endpoint device of the user. In one example, the user endpoint device to which the output is delivered is selected as at least one of the user endpoint device(s) from which the input was collected. In another example, the user endpoint device to which the output is delivered is selected based on an explicit request in the input (e.g., the user explicitly requests in the input that the output be delivered to a specific user endpoint device). In another example, the user endpoint device to which the output is delivered is selected based on information in a profile for the user (e.g., the profile may include a preference that requests all output be delivered to a specific user endpoint device, or that outputs of different modalities be delivered to different specific user endpoint devices). In the absence of a user preference, the user endpoint device to which the output is delivered may be selected based on the capabilities of the user endpoint devices associated with the user. For instance, if the output includes an audio component, then at least the audio component of the output should be delivered to a user endpoint device that is capable of playing audio (e.g., includes a speaker). It should be noted that where the output includes multiple components of different modalities, the multiple components may be delivered to two or more different user endpoint devices.

In optional step 220 (illustrated in phantom), the processing system may receive feedback on the output from the user. In one example, the processing system may explicitly request the feedback on the output from the user. In another example, the processing system may not explicitly request the feedback on the output from the user, but may detect the feedback on the output from further input received after the output is delivered. In another example, the processing system may not explicitly request the feedback on the output from the user, but may observe the actions of the user subsequent to the delivery of the output and may infer the feedback on the output from the actions. For instance, if the user ignores the output, the processing system may infer that the output is not useful or effective for the user's purposes. In another instance, if the user accepts the output and is detected to smile subsequently, the processing system may infer that the output is useful or effective for the user's purposes.

In optional step 222 (illustrated in phantom), the processing system may update the generative artificial intelligence model based on the feedback on the output. In one example, updating the generative artificial intelligence model may include saving the feedback on the output or metadata about the feedback on the output with the generative artificial intelligence model (or with an embedding for the user).

In another example, for every x number of generated prompts and observed performance of those generated prompts (e.g., with respect to the usefulness of the corresponding output), the processing system may update the generative artificial intelligence model or embedding. The generative artificial intelligence model may be saved as a personal generative artificial intelligence model for the user (which may also be task specific).

If the task is a new task (e.g., a task for which the user does not already have a generative artificial intelligence model), updating the generative artificial intelligence model may include fine tuning or initializing the generative artificial intelligence model (or embedding) from existing generative artificial intelligence models for similar tasks (or for other users), using transfer learning. In another example, a user taxonomy or order for generative artificial intelligence model models (or embeddings) may be updated based on information such as the nature of a task, a category of a task, a difficulty level associated with a task, or other task-related information. The generative artificial intelligence model may also utilize meta learning or other techniques to adapt to new tasks.

The method 200 may end in step 224.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

The ability to generate prompts for a generative artificial intelligence model based on multimodal inputs may have a variety of use cases. For instance, examples of the present disclosure may facilitate wireless open RAN (O-RAN) network alignment. In this case, examples of the present disclosure may be used to leverage unified data management (UDM) to determine, retrieve, store, and update subscriber profiles and generative artificial intelligence models. The O-RAN could be enabled to securely collect multimodal device or sensor data for prompt formulations. The O-RAN network could also be leveraged to detect anomalies or out-of-distribution data points based on multimodal data collected from network users. UDM could be further leveraged for centralized privacy and security management of user profiles, generative artificial intelligence models, and embeddings.

Examples of the present disclosure may also provide next-generation capabilities for existing internal chat dialog systems for providers of RAN services. Prompt and response generation and automation can be extended using multimodal inputs, leading to more interactive and evolving prompt structures (e.g., using historical and current user contexts). Secure multi-user determination and management can also be extended using multimodal signals.

In another example, the generative artificial intelligence model may be trained to personalize an extended reality shopping experience. In this case, a customer of an extended reality shopping application or system may use an augmented reality tool to virtually try on clothing, change characteristic of clothing, or design new clothing before purchasing the clothing. The customer may also be able to request three-dimensional printed items or customized products, and the generative artificial intelligence model may be trained to provide example requirements or use cases for the products.

In this case, if prompts for the generative artificial intelligence model could only be generated using text or image inputs, this might make it difficult for the customer to quickly and accurately gauge how the clothing fits and looks on the customer's body. However, incorporating the ability to enhance the prompts with inputs such as gestures, biometric data, and gaze information would allow the generative artificial intelligence model to understand the in-place use for further customizations of the clothing and reducing merchandize returns for the retailer.

In another example, the generative artificial intelligence model may be trained to help a fitness application or system (e.g., a smart treadmill, rowing machine, or stationary bicycle) to adjust a user's exercise routine based on the user's, heart rate, fitness goals, and other health parameters. For instance, the generative artificial intelligence model may add random hills, scenery, and/or other items or obstacles during the user's exercise routine, or may slow down or reduce the number of obstacles on the user's exercise routine.

In this case, if prompts for the generative artificial intelligence model could only be generated using text or image inputs, this might make it difficult to gauge the user's real-time performance. However, incorporating the ability to enhance the prompts with inputs such as biometric data and gaze monitoring data could help the generative artificial intelligence model to better understand the amount of computing resources that should be allocated to build a rich virtual environment, match the user's context preferences (e.g., tired, energized, etc.), and improve user satisfaction with the exercise routine.

In another example, the generative artificial intelligence model may be trained to introduce a personalized or interactive element to educational talks or lectures. For instance, during a lecture, examples of the present disclosure may provide a teacher with automatically generated prompts based on responses from students. In a further example, automated prompts can be formulated on behalf of the students (e.g., during in-person or remote learning sessions).

In this case, the ability to process multimodal inputs may enable personalized learning based on observations of student interactions, which may allow a generative artificial intelligence model to expand on queries (e.g., a query with a text component of “show other examples of classical art similar to this” and an image of an example of classical art). In other examples, a teacher may allow prompts to formulate expansion of material being presented based on student feedback (e.g., student questions related to a specific topic may serve as a trigger for a new prompt that can be used to expand on the topic). In another example, prompts may be constructed to confirm student understanding of material being presented.

In another example, the generative artificial intelligence model may be trained to facilitate smart home interactions. For instance, a homeowner may use a smart home system to cooperatively set up home automations for a child's birthday party, such that various aspects of the home environment (e.g., lighting, temperature, music, food delivery arrangements) are mostly handled automatically by the smart home system.

In this case, relying solely on image or text inputs to formulate prompts would make the guided capabilities of the smart home system less effective by chaining those capabilities to a less intuitive control modality. However, incorporating feedback from the homeowner and the guests would help the smart home system to better determine when to adjust content generation (e.g., switch to story time instead of games) so that the homeowner can participate with less planning-related demands.

In another example, the generative artificial intelligence model may be trained to perform network traffic monitoring. In this case, network traffic volumes and patterns may vary depending on the time of day. For instance, a generative artificial intelligence model may learn that high (e.g., higher than a threshold, mean, or median) traffic volumes may be normal at noon, but the same volumes could indicate a potential security threat if observed at 3:00 AM.

In another example, the generative artificial intelligence model may be trained to perform healthcare monitoring. For instance, a generative artificial intelligence model may learn that specific values for certain patient vital signs might be considered normal during periods of rest, but the same values for those vital signs could indicate a possible health condition if observed during periods of activity or exertion. Contextual anomaly detection may, in this case, help to identify genuine health concerns by considering a patient's activity level.

In another example, the generative artificial intelligence model may be trained to perform seasonal sales analysis. In this case, sales patterns may vary depending on the season. For instance, a generative artificial intelligence model may learn that a sudden drop in sales during a historically high-sales period (e.g., Christmas) is anomalous, but the sudden same drop in sales could be considered normal if observed during an off-peak season.

In another example, the generative artificial intelligence model may be trained to aggregate data from various IoT sensors (e.g., traffic sensors, air quality monitors, and the like) to manage an urban infrastructure of a smart city. For instance, outputs could be used to time the durations of red and green traffic signals, adjust speed limits, plan detours, or the like.

In another example, the generative artificial intelligence model may be trained to aggregate data from various sensors (e.g., weather stations, pollution monitors, and the like) in different locations to track environmental changes. In one example, authorization may ensure that sensitive data, such as the nesting locations of endangered species, is protected.

In another example, the generative artificial intelligence model may be trained to analyze medical imaging data. Generative artificial intelligence, and particularly models like generative adversarial networks and advanced versions of generative pre-trained transformers, can learn from vast amounts of data to generate new, realistic data or to identify patterns and anomalies. As an example, a patient may undergo regular magnetic resonance imaging (MRI) scans over several years, and each scan may be stored in a database along with annotations that indicate the presence or absence of brain tumors. The scans (which may have been processed to standardize the images, remove noise, and normalize intensity values) and annotations may be routinely sent to a generative artificial intelligence system, which may analyze the scans and notify medical professionals when any potential issues are detected (e.g., areas of scans that may indicate the presence of brain tumors). For instance, by comparing a new scan for a patient to a baseline established by a plurality of historical scans for the patient, the generative artificial intelligence system may be able to quickly identify changes or abnormalities and may be able to quantify magnitudes of the changes or abnormalities. These changes or abnormalities may be listed in a report and also visually indicated through the insertion of markers in the new scan.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for multi-modal prompt generation for generative AI, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for multi-modal prompt generation for generative AI (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for multi-modal prompt generation for generative AI (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, a user of a generative artificial intelligence model;
detecting, by the processing system, an input from the user that triggers a query to the generative artificial intelligence model, wherein the input is received via at least one modality other than a text modality or an image modality;
constructing, by the processing system, a prompt for the generative artificial intelligence model based on the input;
executing, by the processing system, the generative artificial intelligence model, using the prompt as an input to the generative artificial intelligence model, to generate an output; and
delivering, by the processing system, the output to a user endpoint device of the user.

2. The method of claim 1, wherein the user is a human user.

3. The method of claim 1, wherein the user is at least one of: an autonomous vehicle, an internet of things device, a drone, or a virtual decision maker for a smart city.

4. The method of claim 1, wherein the identifying comprises identifying a profile for the user, wherein the profile specifies at least one of: the user endpoint device of the user, the generative artificial intelligence model, identifying information of the user, a service to which the user is subscribed, or a preference of the user.

5. The method of claim 1, wherein the at least one modality other than the text modality or the image modality comprises at least one of: a video modality, an audio modality, a multimedia modality, a motion modality, a gesture modality, a biometrics modality, an emotion modality, a location modality, a time modality, a speech characteristic modality, or an extended reality modality.

6. The method of claim 5, wherein the processing system derives a context for the query from the at least one modality other than the text modality or the image modality.

7. The method of claim 1, wherein the generative artificial intelligence model comprises a user-specific model that has been trained for use by the user.

8. The method of claim 7, wherein the generative artificial intelligence model further comprises a task-specific model that has been trained to perform a specific task on behalf of the user.

9. The method of claim 1, wherein the output is generated in a modality that includes at least one of: a video, an audio, a multimedia, a motion, a gesture, a biometrics, an emotion, a location, a time, or an extended reality element.

10. The method of claim 1, wherein the output comprises computer readable instructions that control an operation of the user endpoint device.

11. The method of claim 1, further comprising:
detecting, by the processing system, an anomaly in data collected from a user endpoint device associated with the user;
soliciting, by the processing system, feedback on the anomaly from the user; and
disambiguating, by the processing system, the anomaly based on the feedback on the anomaly.

12. The method of claim 1, further comprising:
receiving, by the processing system, feedback on the output from the user; and
updating, by the processing system, the generative artificial intelligence model based on the feedback on the output.

13. The method of claim 12, wherein the feedback is received through the processing system observing an interaction of the user with the output.

14. The method of claim 12, wherein the updating comprises saving the feedback on the output with the generative artificial intelligence model.

15. The method of claim 12, wherein the updating is performed periodically after a defined number of iterations of the identifying, the detecting, the constructing, the executing, and the delivering.

16. The method of claim 1, wherein the constructing is performed in response to a detection of a predefined event in the input.

17. The method of claim 16, wherein the predefined event comprises an utterance or an observed value of a sensor reading.

18. The method of claim 1, wherein the constructing includes submitting an intermediate exemplar to the user for approval prior to the executing the generative artificial intelligence model.

19. A non-transitory computer-readable medium storing instructions which, when executed by a processing system including at least one processor, cause the processing system to perform operations, the operations comprising:
identifying a user of a generative artificial intelligence model;
detecting an input from the user that triggers a query to the generative artificial intelligence model, wherein the input is received via at least one modality other than a text modality or an image modality;
constructing a prompt for the generative artificial intelligence model based on the input;
executing the generative artificial intelligence model, using the prompt as an input to the generative artificial intelligence model, to generate an output; and
delivering the output to a user endpoint device of the user.

20. A device comprising:
a processing system including at least one processor; and
a non-transitory computer-readable medium storing instructions which, when executed by the processing system, cause the processing system to perform operations, the operations comprising:
identifying a user of a generative artificial intelligence model;
detecting an input from the user that triggers a query to the generative artificial intelligence model, wherein the input is received via at least one modality other than a text modality or an image modality;
constructing a prompt for the generative artificial intelligence model based on the input;
executing the generative artificial intelligence model, using the prompt as an input to the generative artificial intelligence model, to generate an output; and
delivering the output to a user endpoint device of the user.
